(19) United States
(12) Patent Application Publication
(10) Pub. No.: US 2026/0329477 A1
(43) Pub. Date: Oct. 22, 2026

(54) PATTERN GENERATOR FOR DRAM INTERFACE

(71) Applicant: XILINX, INC., San Jose, CA (US)

(72) Inventors: Amit VYAS, Hyderabad (IN); Santosh Krishna PARASURAMPURAM, Hyderabad (IN); Karthikeyan PALANISAMY, Coimbatore (IN)

(21) Appl. No.: 19/182,503

(22) Filed: Apr. 17, 2025

(51) Int. Cl. G06F 3/06

(52) U.S. Cl. CPC G06F 3/0659; G06F 3/0604; G06F 3/0653; G06F 3/0673

(57) ABSTRACT

The examples describe a pattern generator including a control memory configured to store multiple pattern sequences that are pre-configured, a sequencer configured to interpret the multiple pattern sequences stored in the control memory and trigger data and command patterns onto a dynamic random access memory (DRAM) interface, and a test data memory configured to store the data and command patterns to be applied to the DRAM interface during a test process. The control memory includes an instruction random access memory (RAM) and the test data memory includes a pattern RAM. The pattern RAM includes a data (DQ) pattern RAM and a command (CMD) pattern RAM. The multiple pattern sequences are generated for different stages of the DRAM interface including initialization, training, tracking, and post-training maintenance. The sequencer executes each instruction from the control memory in a single clock cycle.

### TECHNICAL FIELD

Examples of the present disclosure generally relate to high-speed data communication systems, and, in particular, to a pattern generator for dynamic random access memory (DRAM) interfaces.

### BACKGROUND

In high-performance dynamic random access memory (DRAM) interfaces, efficient and reliable pattern generation helps in validating various aspects of memory operations such as timing, voltage margins, read/write integrity, and long-term reliability. Traditional pattern generators used in DRAM interface testing rely on static, single-use patterns or need frequent reconfiguration to address different stages of the testing process. These conventional systems often struggle with limited storage capacity, inefficient loop handling, and a lack of flexibility to support a wide range of testing scenarios. Further, testing high-speed DRAM interfaces involves high-throughput pattern generation, which many existing solutions fail to meet due to bottlenecks or excessive setup time. As a result, there is a growing need for a pattern generator that can efficiently manage complex test patterns, handle multiple iterations, and adapt to the evolving needs of different DRAM technologies.

Existing solutions are limited by their inability to store and manage multiple test patterns concurrently, needing manual intervention or time-consuming reconfiguration between tests. Additionally, the lack of efficient loop management and scalability makes it difficult to execute complex test sequences with nested loops or varying conditions without overwhelming the testing system. These limitations hinder the ability to validate DRAM interfaces under different operational scenarios, which can lead to longer testing cycles and reduced testing coverage.

### SUMMARY

One example described herein is a pattern generator including a control memory configured to store multiple pattern sequences that are pre-configured, a sequencer configured to interpret the multiple pattern sequences stored in the control memory and trigger data and command patterns onto a dynamic random access memory (DRAM) interface, and a test data memory configured to store the data and command patterns to be applied to the DRAM interface during a test process. The control memory includes an instruction random access memory (RAM) and the test data memory includes a pattern RAM. The pattern RAM includes a data (DQ) pattern RAM and a command (CMD) pattern RAM. The multiple pattern sequences are generated for different stages of the DRAM interface including initialization, training, tracking, and post-training maintenance. The sequencer executes each instruction from the control memory in a single clock cycle.

One example described herein is a pattern generator including a sequencer configured to interpret multiple pattern sequences that are pre-configured and stored in an instruction random access memory (RAM), where the multiple pattern sequences are generated for different stages of a dynamic RAM (DRAM) interface including initialization, training, tracking, and post-training maintenance and a pattern RAM including a data (DQ) pattern RAM and a command (CMD) pattern RAM, where the pattern RAM is configured to store data and command patterns to be applied to the DRAM interface during a test process.

One example described herein is a method including writing, using a training processor, a start address and a stop address to a sequence configuration register, loading, using a sequencer, the start address on a program counter, fetching, using the sequencer, instructions from a control memory, each instruction specifying a next instruction location and pattern pointers to a test data memory, based on a pattern pointer in an instruction, fetching, using the sequencer, a pattern from the test data memory, and fetching and executing, using the sequencer, the instructions until the stop address is reached.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIGS. 1A-1B illustrate a pattern generator, according to an example.

FIGS. 2A-2B illustrate an execution flow of the pattern generator, according to an example.

FIG. 3 illustrates a method for running the pattern generator of FIGS. 1A-1B, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Existing pattern generators for dynamic random access memory (DRAM) interfaces face several limitations that hinder their effectiveness and flexibility in high-speed memory testing. One challenge is the need for frequent reconfiguration. As test scenarios evolve or as different DRAM configurations are tested, the conventional pattern generator needs extensive reprogramming or adjustments to accommodate new sequences, which can lead to inefficiencies and increased test time. This frequent reconfiguration not only adds complexity to the testing process but also slows down the validation cycle.

Another limitation is the limited storage capacity of many pattern generators. The amount of data that can be stored for testing is constrained by the available memory, which can restrict the scope and variety of test patterns. This limitation can be problematic when testing large or high-speed memory systems, as it may not be possible to store a sufficient number of patterns to simulate real-world conditions or perform extensive stress testing.

Inefficient loop handling is another challenge faced by traditional pattern generators. Many systems struggle to efficiently handle repeated sequences or loops within test patterns. This inefficiency can result in unnecessary delays, as the pattern generator may need to reload or reconfigure pattern sequences for each iteration. In scenarios where extensive looping is involved, this can lead to performance bottlenecks.

Finally, conventional pattern generators handle single-use patterns. While this can be suitable for basic functionality testing, it limits the ability to test a wide range of real-world scenarios that use dynamic or adaptive pattern generation. Single-use patterns lack the flexibility needed to test varying data flows, burst traffic, or complex access patterns that may occur in actual operational environments.

These limitations can significantly reduce the efficiency, flexibility, and scalability of testing processes for DRAM interfaces, making it difficult to fully validate the performance and reliability of modern memory systems. Addressing these challenges involves advancements in pattern generation technology that allow for more flexible, efficient, and scalable testing approaches.

In view of such limitations and challenges, the examples present a pattern generator that resolves such issues. The example pattern generator includes pre-configured pattern storage, which eliminates the need for frequent reconfiguration, streamlining the testing process and significantly reducing setup time. This feature allows a wide variety of test patterns to be pre-stored and readily available, enabling quick transitions between different testing phases, such as initialization, training, tracking, and post-training maintenance. With enhanced storage capacity, the example pattern generator can store longer and more complex test sequences without running out of memory, thus ensuring comprehensive testing without sacrificing performance or the need for constant pattern reloads. Moreover, the example pattern generator offers versatility in supporting multiple DRAM interfaces and training requirements. Its scalability makes it capable of adapting to future DRAM technologies, ensuring that it can be easily configured to handle memory types, such as double data rate (DDR), low-power DDR (LPDDR), high-bandwidth memory (HBM), or emerging memory standards. Whether testing low-speed consumer-grade DRAM or high-bandwidth memory systems, the pattern generator is capable of adjusting to varying memory architectures, clock frequencies, and data widths. This flexibility makes it a valuable tool for a wide range of applications.

The example pattern generator is not limited to only testing processes for DRAM interfaces. The example pattern generator can also be used to calibrate the input/output (I/O) of the DRAM before the controller starts sending the user traffic on the I/O interface. In other words, in operation, the DRAM is initialized, and then, based on the operating conditions, the DRAM is configured, and its interface is calibrated. Calibration refers to finding the eye and adjusting the sampling clock or strobes accordingly. As such, the example pattern generator serves multiple functions beyond testing DRAM interfaces. The example generator can be used for I/O calibration, training of the DRAM interface, and even boot-up initialization.

Efficient loop handling is another feature of the example pattern generator. The system’s ability to manage nested loops and execute them in a stack-based approach ensures that complex test sequences with multiple iterations can be executed efficiently, without introducing bottlenecks. The combination of single-cycle instruction execution and efficient loop management enables the example pattern generator to maintain high throughput, which is valuable for high-speed DRAM interfaces operating at high data rates. The ability to execute each instruction in a single clock cycle minimizes latency, ensuring that the pattern generator can keep pace with fast memory operations and generate patterns without delay.

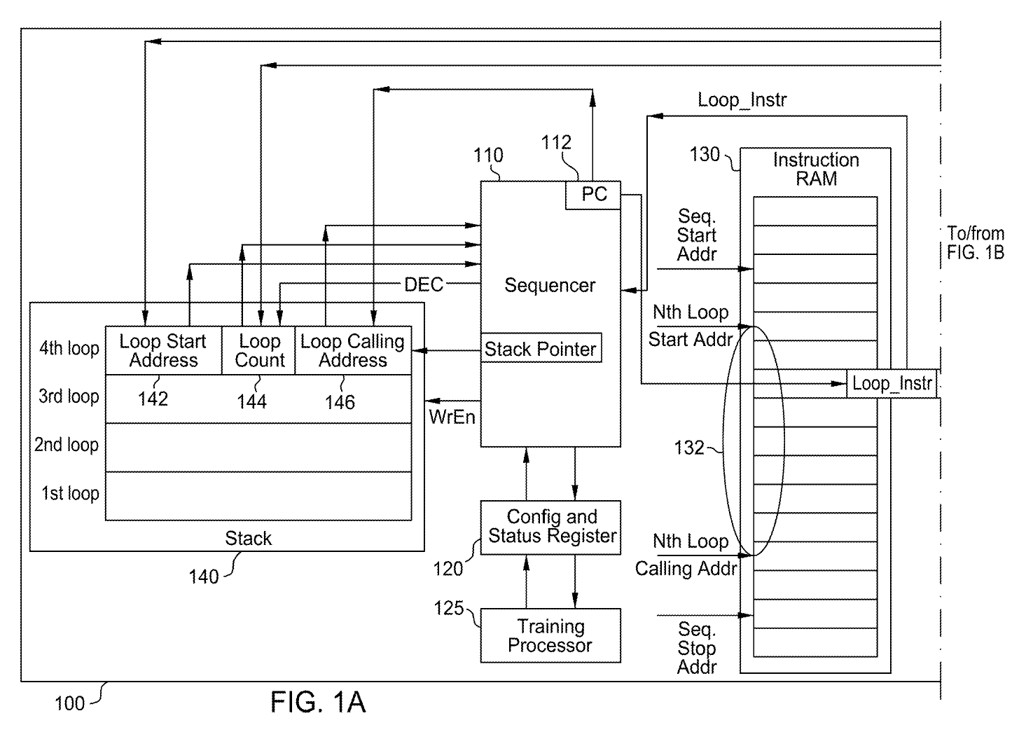

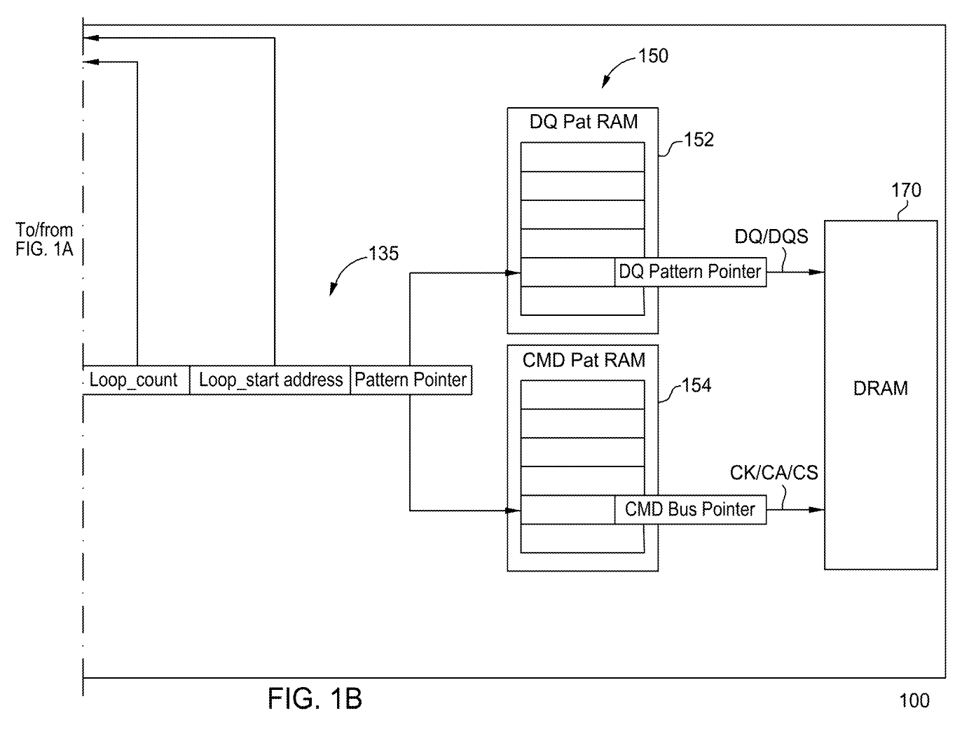

FIGS. 1A-1B illustrate a pattern generator, according to an example.

The pattern generator 100 includes a sequencer 110, a sequencer configuration register 120, an instruction RAM 130, and a pattern random access memory (RAM) 150. The pattern RAM 150 may include a first pattern RAM 152 and a second pattern RAM 154. The first pattern RAM 152 may be a data (DQ) pattern RAM and the second pattern RAM 154 may be a command (CMD) pattern RAM. The components of the pattern generator 100 for a DRAM interface facilitate the generation and management of various data and command sequences that drive the DRAM 170 (or DRAM interface) during, e.g., testing. However, the pattern generator 100 is not limited to only testing DRAM interfaces. The pattern generator 100 can also be used for I/O calibration, training for the DRAM interface, and boot-up initialization.

The I/O calibration provides for proper signal integrity and timing between the DRAM and the memory controller. The pattern generator 100 may help in impedance matching, skew compensation, and duty cycle correction. Before the DRAM can be used, the memory controller needs to be trained for different parameters. The pattern generator 100 can help in executing training sequences, which may include write leveling, read training, reference voltage training, and equalization training. The pattern generator 100 can help by sending specific training patterns to assist in fine-tuning the different parameters. During boot-up time, the pattern generator 100 can help initialize the DRAM interface by, e.g., pre-loading known test patterns, verifying clock and power sequencing, assisting in mode register programming, and testing and validating DRAM cells. As such, according to all the examples below, the pattern generator 100 may serve any and all such functions.

The pattern generator 100 creates and drives patterns on DRAM data and command lines. In one example, the pattern generator 100 tests and validates DRAM interfaces (e.g., the DRAM 170) and ensures the integrity of the data transfer process. The pattern generator 100 produces specific, repeatable patterns of data and control signals that are sent to the DRAM 170, simulating real-world operating conditions or edge cases. In operation, the pattern generator 100 first initializes the DRAM 170 with a reset command and configures the memory controller with the desired configuration (e.g., timing parameters, row/column sizes). A sequence of write commands is sent to the DRAM 170, followed by read commands to check for data consistency. The pattern generator 100 then introduces complex patterns, such as random bursts of read/write operations, to evaluate the performance and reliability of the system under heavy load. Simultaneously, error detection logic checks the data integrity and logs any mismatches between expected and actual data values. The pattern generator 100 does not depend on any data protocol. As such, the pattern generator 100 is scalable and can be applied to any type of DRAM interface.

The sequencer 110 is responsible for controlling the flow of data and commands in the pattern generator 100. The sequencer 110 interprets the sequences stored in the instruction RAM 130 and triggers the appropriate data and command patterns onto the DRAM interface. The sequencer 110 controls the timing and ordering of operations by reading instructions from the instruction RAM 130 and then driving the corresponding data/command lines of the DRAM 170. The sequencer 110 ensures that each operation is executed in the correct order and that timing constraints, such as command and data alignment, are adhered to.

The sequencer 110 includes a program counter (PC) 112. The PC 112 is responsible for tracking the current instruction within the sequence and determining the next instruction to execute. The PC 112 stores the address of the current instruction in the instruction RAM and increments or jumps to the appropriate address based on the flow of execution. The PC 112 ensures that the sequencer 110 executes the test patterns in the correct order. The PC 112 acts as a pointer that guides the execution by determining the next instruction. When a sequence is completed, the PC 112 can be configured to either repeat the sequence or jump to another sequence based on the testing requirements. The PC 112 increments by one after each instruction is executed, but the PC 112 can also jump to different addresses based on conditions, such as when a loop or conditional branching is encountered. This enables the pattern generator 100 to support complex and flexible test sequences. The PC 112 handles loops within the pattern sequence. When a loop 132 is encountered, the PC 112 can jump to the starting address of the loop 132, repeating the specified instructions until the loop count is exhausted, after which the program continues to the next set of instructions.

The sequencer 110 also includes control logic. The control logic coordinates the overall functioning of the sequencer 110. The control logic ensures that the correct operations are executed at each step of the pattern generation process by interpreting the instructions stored in the instruction memory and controlling the flow of data. The control logic receives inputs from the PC 112 and directs the execution of each instruction. The control logic decodes the instruction and generates control signals that inform other components of the system, such as data generators, memory access units, or signal drivers, when and how to perform their respective operations. The control logic also manages the execution of nested loops. The control logic keeps track of loop counters and determines when a loop should repeat or terminate. For example, if a loop involves a fixed number of iterations, the control logic decrements the loop counter after each iteration, and when the counter reaches zero, the logic instructs the PC 112 to continue with the next instruction.

The sequencer 110 further communicates with a stack RAM 140 that manages loop execution using parameters like loop start address, loop count, and loop calling address. This enables efficient execution of repetitive sequences, such as training, calibration, and adaptive tuning in high-speed DRAM interfaces. The stack RAM 140 serves as a control structure that allows the sequencer 110 to execute nested loops, manage recursion, and track execution flow. The loop start address 142 specifies where the loop begins in the instruction RAM 130. The sequencer 110 jumps to this address when starting a loop iteration. The loop count 144 defines the number of times the loop should execute. Each iteration decrements this counter and the loop exits when it reaches zero. The loop calling address 146 stores the return address when the sequencer 110 enters a nested loop. The loop calling address 146 allows the sequencer 110 to resume execution at the correct location after completing a loop or subroutine. The loop execution flow includes loop initialization, loop execution, loop completion, and nested loop and subroutine calls.

The sequencer configuration register 120 holds settings that define how the sequencer 110 operates. The sequencer configuration register 120 can configure parameters such as the sequence start address, sequence repeat count, timing information, and conditions under which the sequencer 110 should halt or loop. The sequencer configuration register 120 allows the user to specify how sequences are fetched from the instruction RAM 130. These settings may include start and stop addresses for the sequence in memory, number of iterations or repetitions for a sequence, conditional branching for more complex patterns, and timing configurations to ensure the sequencer 110 generates accurate and synchronized data/command sequences. The sequencer configuration register 120 may be programmable via a control interface to allow dynamic reconfiguration during, e.g., testing.

The sequencer configuration register 120 communicates with a training processor 125 to coordinate various initialization, calibration, and training routines in high-speed DRAM interfaces. The training processor 125 may be a microcontroller, controller, firmware core, or embedded logic. The training processor 125 writes to the sequencer configuration register 120 to set parameters such as, but not limited to, training mode selection, timing adjustments, and control flags for enabling or disabling specific training sequences.

The training processor 125 programs the sequencer configuration register 120 to configure the sequencer dynamically. This allows for real-time adjustments to the behavior of the pattern generator 100 without the need for manual intervention or hardware reconfiguration. The training processor 125 interacts with the sequencer configuration register 120 to update the configuration fields as needed, depending on the testing phase, DRAM interface specifications, and the type of pattern being generated. For example, during the initialization phase, the training processor 125 may configure the sequencer configuration register 120 to execute a simple pattern with minimal loops and no branching. In contrast, during the more complex training phase, the training processor 125 may configure the sequencer configuration register 120 to handle nested loops, multiple branches, and complex timing adjustments to stress-test the DRAM interface 170 and determine optimal performance conditions.

The sequencer configuration register 120 serves as an interface for the training processor 125 to configure and control the behavior of the sequencer 110, enabling customized execution of pattern sequences based on the specific testing requirements. The sequencer configuration register 120 includes several configuration fields that define various operational parameters for the sequencer 110, ensuring that the pattern generation is tailored to the specific needs of the DRAM interface being tested. These fields enable flexible pattern generation and ensure that different testing stages (e.g., initialization, training, tracking, post-training maintenance) can be supported efficiently. Some of the configuration fields include, but are not limited to, instruction address, loop parameters, branch conditions, timing parameters, and interrupt and status flags.

The instruction address field holds the starting address or pointer for the first instruction in the pattern sequence. The training processor 125 can use this field to specify where the sequencer 110 should begin executing a pattern, allowing for dynamic initiation of test sequences.

The loop parameters define the loop boundaries and loop counts, enabling the training processor 125 to specify how many times a particular pattern or sequence of patterns should be repeated. The configurability of loop parameters allows for efficient handling of complex, multi-iteration test cases without the need for manual reprogramming.

Branching conditions define when and how the sequencer 110 should jump to different parts of the pattern sequence. The training processor 125 can program these conditions to introduce dynamic changes during the execution of a pattern, such as jumping to a different sequence or altering the flow based on specific results or flags.

Timing parameters control the timing of specific actions within the pattern sequence. They may include delays between instructions, timing adjustments for specific operations, and other timing-based configurations that help in validating DRAM timing margins, such as read/write latency, setup/hold times, and recovery times.

Interrupt and status flags include bits that enable or disable interrupt functionality within the sequencer 110. Interrupts can be used to signal the sequencer 110 to pause or adjust the current sequence based on external events or internal status updates. Status flags may be set to monitor conditions such as error detection, loop completion, or sequence termination.

The first pattern RAM 152 may be referred to as DQ pattern RAM. The DQ pattern RAM stores predefined test patterns that are sent over the data (DQ) lanes of the memory interface. The DQ pattern RAM is used for data integrity verification, eye diagram calibration, and signal integrity testing.

The pattern RAM 150 stores the actual data patterns that will be applied to the DRAM 170 during the test process. The pattern RAM 150 may be referred to as test data RAM. These patterns are not limited to just data values but also include timing configurations, command sequences, and control signals that govern the interaction with the DRAM interface. The data (DQ) lines are the bidirectional data lines in the DRAM interface, and the patterns stored in the pattern RAM 150 specify the values that need to be driven onto these lines during various stages of the test. These data values may represent write operations, read operations, or any other data manipulations for testing memory performance or integrity. The command (CA) lines are used to send commands to the DRAM interface, such as read/write commands, refresh commands, or other control commands that manage the operation of the DRAM interface. Pattern RAM 150 stores the exact command sequences that will be driven on the CA lines during the test. The chip select (CS) lines are used to enable or disable specific DRAM chips within a multi-chip system. The pattern RAM 150 stores patterns related to the chip selection, controlling which DRAM chip is active and participating in a given test sequence.

The pattern RAM 150 supports prefetching of patterns, meaning that the actual test patterns for the DQ, CA, and CS lines are loaded in advance based on pointers provided by the instruction RAM 130. This system allows for high-speed pattern generation by ensuring that the sequencer 110 can fetch the next set of patterns without delay. Each instruction in the instruction RAM 130 includes a pointer to a specific location in the pattern RAM 150, where the corresponding pattern data for the DQ, CA, and CS lines is stored. When the sequencer 110 executes an instruction, the control logic uses this pointer to fetch the relevant pattern from the pattern RAM 150.

The second pattern RAM 154 may be referred to as CMD pattern RAM. The CMD pattern RAM stores predefined command sequences that control the behavior of the memory interface. The commands include memory read/write operations, mode register settings, and refresh commands.

The second pattern RAM 154 defines the test sequence, whereas the first pattern RAM 152 stores the test data. During memory testing, the second pattern RAM 154 triggers read/write transactions, whereas the first pattern RAM 152 stores the expected or transmitted data. Stated differently, the pattern RAM 150 stores the actual data that will be transmitted along the DRAM data lines. While the instruction RAM 130 defines the commands and the order in which they are executed, the pattern RAM 150 holds the specific data words to be written or read during those operations. When a write command is issued by the sequencer 110, the pattern RAM 150 provides the corresponding data to be sent to the DRAM 170. During read operations, the pattern RAM 150 can be used to check the expected data that should be read back from the DRAM 170, enabling the comparison of expected versus actual results for error detection.

Therefore, the pattern RAM 150 ensures that patterns are readily available when needed, without introducing latency or performance bottlenecks. The pattern RAM 150 allows single-cycle access to pattern data, ensuring that the patterns for the DQ, CA, and CS lines can be retrieved and applied to the DRAM interface on every clock cycle. This is beneficial for high-speed pattern generation, as delays in fetching or applying patterns may result in inaccurate testing or failure to meet timing constraints. The pattern RAM 150 may be organized into different sections, with separate regions for DQ, CA, and CS line patterns. This allows for more efficient storage and retrieval of different pattern types, ensuring that the data patterns are applied to the correct lines without interference. The pattern RAM 150 is scalable, supporting different data widths, clock speeds, and DRAM interface standards. As the DRAM technologies evolve, the pattern RAM 150 can be configured to support larger pattern sets or additional signal lines, making it adaptable to newer DRAM generations (e.g., DDR6).

The first pattern RAM 152 is separated from the second pattern RAM 154. The separation of the DQ pattern RAM from the CMD pattern RAM serves multiple purposes. Keeping them separate allows for flexible control over command sequences and data payloads independently. Commands often stay the same for multiple patterns. If CMD and DQ patterns were stored together, the same command sequences would be repeatedly stored, leading to wasteful duplication. By separating them, the same command can be used for multiple different data patterns without storing redundant copies. With a separate CMD pattern RAM, the same sequence of memory commands can be reused for different test cases. The DQ pattern RAM can be changed independently without modifying the command sequence. Also, some test sequences need different DQ patterns but the same CMDs. If CMD and DQ were combined, changing one would involve rewriting both. With separate RAMs, CMD sequences remain fixed and only DQ patterns need to be updated. This reduces the overall memory footprint and improves performance. Further, by separating the first pattern RAM 152 from the second pattern RAM 154 enables each to have a different size. The DQ pattern RAM stores data payloads that can be large, whereas the CMD pattern RAM stores commands, addresses, and control signals, which need fewer bits. For example, for an LPDDR5 interface, the CMD pattern RAM may be 128B and the DQ pattern RAM may be 32KB.

The instruction RAM 130 stores the high-level instructions or sequences that the sequencer 110 will execute. The instruction RAM 130 may be referred to as control memory. These instructions define the specific pattern of commands and data that will be sent to the DRAM 170. The instruction RAM 130 is used by the sequencer 110 to fetch instructions that determine the timing, type, and order of operations. The instruction RAM 130 holds command sequences (e.g., read, write, precharge, refresh), address information (e.g., row/column addresses for DRAM access), timing information (e.g., delays between commands), and any control information used for the sequence flow (e.g., branching or conditional operations). The sequencer 110 fetches data from the instruction RAM 130 in a structured manner, with each instruction representing a step in the memory test or validation process. Each instruction has multiple fields 135. For example, each instruction may have a loop instruction field, a loop count field, a loop start address field, and a pattern pointer field. The loop instruction field identifies an instruction as a loop instruction. The loop count field stores how many times the loop should execute. Every time the loop runs, this value decrements until it reaches zero. The loop start address field stores the starting address of the loop. When the loop repeats, the PC 112 jumps back to this address. The pattern pointer field points to a specific pattern or data sequence used during execution.

Stated differently, the function of instruction RAM 130 is to store the instructions for various pattern sequences that are executed by the sequencer 110. These instructions are the building blocks of the test patterns, defining the actions the pattern generator 100 should take, such as data writes, read operations, timing adjustments, or conditional branches. One advantages of the instruction RAM 130 is its ability to store multiple pattern sequences simultaneously. This feature enables the system to handle different testing phases (e.g., initialization, training, tracking, and maintenance) without the need for frequent reconfiguration or reloading of pattern data. Each test sequence can be independently stored in the instruction RAM 130, and the sequencer 110 can jump between these sequences as needed, depending on the current stage of the testing process. Pattern sequences can be stored in a linear or segmented fashion, where each sequence is stored at a distinct memory address. The PC 112 within the sequencer 110 will point to the relevant instruction address in the instruction RAM 130 and execute the corresponding pattern.

The types of instructions stored in instruction RAM 130 can vary widely, depending on the test requirements. These instructions may include data Writes/Reads. Such instructions generate specific data values to be written to or read from the DRAM interface. Timing adjustment instructions may be provided that introduce delays or synchronize operations to test the timing margins of the DRAM 170. Conditional branch instructions may be provided that alter the flow of the sequence based on specific conditions (e.g., flags, status bits, or external inputs). Loop instructions may be provided that initiate, repeat, or exit loops, allowing for multiple iterations of the same pattern sequence.

In one example, the sequencer 110 may be configured to execute a series of read/write operations in a loop, accessing specific rows and columns of the DRAM 170. The instruction RAM 130 may contain addresses and command types for each operation, while the pattern RAM 150 (e.g., the first pattern RAM 152 and the second pattern RAM 154) holds the actual data values to be written to the DRAM 170 during each write operation. The sequencer configuration register 120 controls the number of iterations, allow the looping of patterns, or enables certain conditions to pause or adjust the sequence based on predefined criteria.

Existing pattern generators for DRAM interfaces face several limitations that hinder their effectiveness and flexibility in high-speed memory testing. Such challenges include the need for frequent reconfiguration, limited storage capacity, inefficient loop handling, and single-use patterns. The pattern generator 100 overcomes such issues.

In one example, the pattern generator 100 allows for multiple pattern sequences to be pre-configured and stored in advance. This approach eliminates the need for frequent reconfiguration during testing, streamlining the testing process. By storing a variety of test patterns in memory ahead of time, the pattern generator 100 can switch between different sequences without the need for manual adjustments or downtime, thus improving overall efficiency.

Storing multiple patterns in advance reduces the need for on-the-fly reconfiguration, allowing the pattern generator 100 to operate seamlessly through different test scenarios. Test engineers can pre-define a wide range of sequences based on test requirements, including different address patterns, data patterns, and timing configurations. This results in more efficient testing as the pattern generator 100 can quickly retrieve the next sequence from memory, without waiting for reprogramming or manual intervention.

By pre-configuring the sequences, the training processor 125 spends less time adjusting or generating patterns dynamically. The workload is offloaded to the pattern generator 100, which can handle pattern switching and timing autonomously. This reduces the computational burden on the training processor 125, freeing it up to focus on other tasks and improving overall system performance.

With multiple sequences available, the pattern generator 100 can automatically cycle through a variety of test patterns, enabling comprehensive testing without delays. This is beneficial when conducting stress tests, performance benchmarking, or verifying memory operation under different conditions. The ability to pre-load and manage large sets of patterns also ensures that complex testing scenarios, such as edge cases or randomized access patterns, can be efficiently executed.

By utilizing external storage solutions (e.g., larger RAM modules or even flash storage), multiple pattern sequences can be stored in bulk, expanding the overall storage capacity of the pattern generator 100. This is beneficial for high-speed DRAM testing, where large amounts of data and various access patterns need to be tested. The increased storage capacity enables the pattern generator 100 to handle more complex and diverse test cases, which may be impractical with a more limited pattern set.

Pre-configured sequences can be dynamically managed to allow for different patterns to be selected or reused across multiple tests. This flexibility is useful for long-term testing, where multiple sequences can be applied repetitively without reprogramming the pattern generator 100. Additionally, the pattern generator 100 enables easy updates to the pattern set without disrupting ongoing tests, as new sequences can be added or adjusted in the storage without the need for significant changes to the overall test setup.

Pre-configured sequences also save block RAM (BRAM) space. BRAM is usually used for core design functions, and using it for test patterns limits available memory for actual processing. Pre-loading test patterns into the pattern RAM 150 allows for quick retrieval without dynamically consuming BRAM. Also, large test sequences would consume significant BRAM is stored there. Offloading these test patterns to the pattern RAM 150 ensures the BRAM remains available for other critical functions.

In a practical application, in a DRAM testing setup, a series of pre-configured test sequences may be loaded into the pattern generator 100 at the start of a test session. These sequences can include patterns for basic read/write operations to validate memory integrity, stress testing patterns that involve random or burst accesses to simulate high traffic conditions, edge cases such as simultaneous reads/writes to multiple banks or interleaved commands to test timing and concurrency handling, and specific command sequences that trigger complex DRAM operations like refresh cycles or row activation. The pattern generator 100 can then autonomously switch between these sequences during the test, executing them in a predetermined order or based on specific conditions, without the need for manual intervention or delays for reconfiguration.

As a result, by pre-configuring and storing multiple pattern sequences in advance, the pattern generator 100 for the DRAM 170 can operate more efficiently, reducing the need for frequent reconfiguration and lowering the training processor’s workload. This approach not only improves test efficiency and reduces downtime but also allows for more comprehensive and scalable testing, which is beneficial for verifying the performance and reliability of modern memory systems.

In another example, the pattern generator 100 has increased storage capacity, which enables the storage of multiple pattern sequences directly in the instruction RAM 130 and the pattern RAM 150 (e.g., the first pattern RAM 152 and the second pattern RAM 154). This approach ensures that a wide variety of test patterns and sequences are available without the need for frequent reconfiguration or the delay of loading patterns from external memory.

By expanding the instruction RAM 130, the pattern generator 100 can store a much larger set of high-level instructions, enabling a broader range of test scenarios. This allows for different sequences of DRAM commands (e.g., read, write, precharge, refresh, etc.) to be pre-defined and loaded into memory, without the need to reload or reprogram the sequence memory for each new test. With larger instruction RAM, the pattern generator 100 can switch between sequences during testing, ensuring that complex test cases (e.g., varying row/column accesses, burst patterns, or timing-dependent operations) are executed without interruption or delay. Pre-storing a comprehensive set of sequences ensures that the sequencer can quickly fetch the necessary commands without relying on slower external memory, improving overall test throughput.

Enhanced pattern RAM 150 allows large sets of data to be stored and accessed quickly during testing. Each test pattern can include data for multiple write operations across different address locations, and with an expanded pattern RAM, these data sets can be preloaded and ready to use as soon as they are needed. The increased storage capacity allows for the inclusion of a variety of data types, including fixed, random, and complex data patterns. With larger pattern RAM, testing can simulate a wider range of realistic access patterns, improving test accuracy and coverage. For high-capacity DRAM systems (e.g., DDR4/DDR5), the increased pattern RAM can store enough data for large-scale testing, such as stressing memory with large sequential writes or random accesses across multiple banks, ensuring that the memory’s performance is validated under diverse conditions.

Stated differently, by constructing the pattern generator 100 to be scalable and adaptable, it ensures compatibility with future DRAM interfaces without the need for hardware changes, but only needs minor software updates. DRAM technologies (DDR4, DDR5, LPDDR5, HBM, graphics DDR (GDDR), etc.) evolve, but the fundamental testing process remains similar. A configurable pattern generator ensures new DRAM types (e.g., DDR6) can be supported with only firmware or microcode updates instead of redesigning the hardware. The hardware stays unchanged and only the pattern sequences and training algorithms need to be updated. The pattern generator 100 fetches commands (CMD pattern RAM) and data (DQ pattern RAM) dynamically, making it agnostic to the DRAM type. As such, in one example, suppose the current hardware supports DDR5 testing. In the future, DDR6 will need a slightly different command/data pattern. Instead of modifying the hardware, the CMD pattern RAM and DQ pattern RAM are updated with DDR6-compatible sequences. The same pattern generator logic remains unchanged, ensuring rapid adoption of new standards.

With both the instruction and pattern RAMs storing the data in advance, the need for reconfiguration during testing is reduced. Patterns and sequences are preloaded, enabling faster transitions between different tests, reducing overall test time. Having all necessary patterns readily available in memory ensures that the testing process is consistent, with no loss of synchronization or timing issues due to reloading data. This is beneficial for high-speed memory testing, where precision and timing are key to detecting potential issues. The enhanced storage enables testing of complex, long-running scenarios that involve repeated use of various test patterns and sequences. This is useful for stress tests, burn-in tests, or reliability testing, where diverse patterns are applied over long periods.

A larger storage capacity means that test engineers can configure and store multiple test cases within the pattern generator 100, eliminating the need to constantly load or modify patterns between test iterations. This results in a more streamlined and automated test setup. With sufficient storage, the pattern generator 100 can adapt dynamically based on feedback or test results, switching between different sequences and patterns based on test conditions or detected anomalies.

In a practical application, where a DRAM interface needs to be tested for reliability under varying conditions, by utilizing enhanced storage capacity in both the instruction RAM 130 and the pattern RAM 150, the following may occur. The instruction RAM 130 holds a series of commands for testing different DRAM operations (e.g., read, write, refresh) with varying timing and address configurations. The pattern RAM 150 stores the corresponding data for each sequence, which may include patterns such as all zeros, all ones, pseudo-random data, and even user-defined complex data patterns. During the test, the pattern generator 100 can quickly fetch the sequences and corresponding data from memory, execute them in succession, and test the DRAM’s response to diverse access patterns and stress conditions. The pattern generator 100 can switch between sequences without manual intervention, ensuring that the test continues smoothly and efficiently, even under complex or extended test conditions.

As a result, by enhancing the storage capacity of both the instruction RAM 130 and the pattern RAM 150, the pattern generator 100 can store a wide variety of instructions and data patterns in advance, ensuring that the necessary patterns are readily available throughout the test process. This approach improves test efficiency by eliminating the need for frequent reconfiguration, reducing latency, and allowing for more complex and comprehensive testing scenarios. Ultimately, this enhanced storage capability enables faster, more accurate, and more scalable testing for DRAM interfaces, contributing to more robust memory system validation and performance analysis.

In another example, the pattern generator 100 uses nested loops within the sequencer 110, employing a stack-based approach for efficient execution of complex pattern sequences. This approach improves performance by enabling the pattern generator 100 to handle test scenarios with multiple levels of iteration and repeated pattern sequences, which is beneficial for exhaustive memory testing and validation.

The sequencer 110 can support multiple levels of loops, allowing patterns to be executed repeatedly with variations in data or addresses. For example, a test pattern may be repeated for a set number of iterations, with different data values or timing parameters applied at each level. This is useful for scenarios such as stress testing, where repetitive patterns are needed across multiple addresses or banks. The stack-based approach enables the sequencer 110 to manage multiple loops and sub-loops efficiently. Instead of reloading or reconfiguring the test sequence each time a loop is encountered, the sequencer 110 uses the stack RAM 140 to keep track of the current loop level, the number of iterations, and any specific variations used for each iteration. This allows for highly flexible and scalable loop management without involving significant overhead or delay.

Nested loops allow for more intricate and diverse testing patterns by enabling variations in loop parameters. For example, a test scenario may involve a primary loop that executes a set of basic DRAM operations (e.g., read/write), with secondary loops that vary the timing, address ranges, or data patterns for each iteration. This results in better test coverage, as it can simulate a broader range of memory access scenarios. The stack-based approach allows the sequencer 110 to dynamically adjust the behavior of loops without the need to pause or reconfigure the entire pattern sequence. This means that the pattern generator 100 can adjust or break out of nested loops depending on test results or specific conditions, making the testing process more adaptive and efficient.

Rather than having to store each individual iteration of a loop as a separate pattern, the stack-based approach ensures that the sequencer 110 only needs to store the loop parameters and sequence logic. This reduces memory usage, as the same pattern can be reused multiple times with different loop parameters, reducing the overall storage requirements. By handling loop iterations internally, the sequencer 110 can reduce the time spent reconfiguring or reprogramming the pattern generator 100. This leads to faster test execution, as the sequencer 110 can focus on pattern execution rather than constant reconfiguration of test parameters or sequences.

In scenarios like burn-in tests, where a pattern needs to be repeated thousands or millions of times, nested loops with a stack-based approach provide a way to execute the pattern efficiently. The sequencer 110 can manage long-running tests without storing every individual iteration in memory, making it feasible to run extensive tests on high-capacity DRAM systems without overwhelming the pattern generator’s storage or processing capacity. The stack-based approach scales well for more complex test scenarios, where multiple levels of nesting are needed. For example, a primary loop may iterate over a sequence of command patterns, while secondary loops can vary the data or timing for each access. The stack RAM 140 ensures that these nested loops are handled efficiently, even when the number of iterations grows significantly.

With nested loops, it becomes easier to introduce error detection mechanisms at different levels. For example, if a failure occurs during a specific loop iteration, the sequencer 110 can break out of the loop and flag the error without needing to restart the entire pattern. This allows for faster error isolation and troubleshooting. If specific patterns are identified as problematic or needing further scrutiny, the stack-based sequencer can adjust the loop parameters dynamically, focusing on critical parts of the test without the need for complete reconfiguration. This enhances the flexibility and adaptability of the testing process.

In a practical application, in a DRAM stress test, the pattern generator 100 can be set up with the following nested loop structure. A primary loop, where the outer loop runs through a sequence of basic operations like reads and writes to the DRAM. A first secondary loop, where within each primary loop iteration, the first secondary loop may vary the address range or bank selection, applying the same set of read/write operations across different memory regions. A second secondary loop, where the second secondary loop may vary the data pattern, using different data values (e.g., all ones, all zeros, random patterns) for each iteration of the primary loop. A third loop may also be used to adjust timing parameters, such as delays or burst lengths, within the same test scenario. The sequencer 110 uses the stack RAM 140 to track the current loop level, ensuring that the correct pattern is applied at each iteration and allows for transitions between different loop conditions. This approach enables comprehensive testing without the need for constant reconfiguration or excessive storage requirements.

As a result, integrating nested loops with a stack-based approach into the sequencer 110 of the pattern generator 100 allows for efficient execution of complex pattern sequences. This approach enables dynamic test scenarios with multiple levels of iteration, improving test coverage, performance, and flexibility. By using this approach, the pattern generator 100 can efficiently handle complex memory tests, optimizing resource usage and ensuring that the DRAM 170 is validated under diverse conditions.

In another example, the pattern generator 100 for DRAM interfaces has the ability to generate a wide range of patterns for different stages of the DRAM interface lifecycle, such as initialization, training, tracking, and post-training maintenance. By enabling the pattern generator 100 to handle the entire spectrum of DRAM operations, from setting up the memory interface to ensuring it continues to operate optimally over time, this approach can improve the effectiveness and flexibility of memory testing.

During the initialization phase, the DRAM 170 needs to be brought into a known state, ensuring all memory cells, address lines, and data buses are properly aligned and ready for use. The pattern generator 100 is capable of producing initialization sequences that handle address mapping to ensure correct mapping of DRAM addresses to physical locations, low-level control sequences to power up memory, establish correct voltage levels, and set timing parameters for read/write operations, pre-charge sequences to ensure all rows are properly prepared for future reads and writes, and command sequences such as row/column addressing and refresh cycles to prepare the DRAM 170 for normal operation. The pattern generator 100 can provide custom patterns for initialization, ensuring that the DRAM 170 starts in a consistent, error-free state before moving to the next phase.

Training is a phase for fine-tuning the memory interface. Training includes adjusting timing parameters, such as read and write delays, clock calibration, and voltage margins, to ensure optimal data integrity and high-speed operation. The pattern generator 100 supports pattern sequences that stress the interface by testing different access scenarios (e.g., burst writes, random accesses, simultaneous reads/writes). The pattern generator 100 also needs to generate patterns that test the timing margins and eye diagram characteristics, ensuring that the interface is operating within the designated voltage and timing margins. Complex patterns can simulate clock-skew, signal degradation, or voltage fluctuations, allowing for real-world stress testing during the training process. Additionally, the pattern generator 100 can support feedback mechanisms during training, allowing the system to adjust and tune parameters based on real-time performance metrics, such as error rates or timing violations.

Stated differently, the pattern generator 100 in the training phase is responsible for generating and applying specific test patterns that stress different aspects of the DRAM interface. These patterns calibrate the interface by exercising different signal paths, identifying potential weak points, and ensuring that the memory controller and the DRAM cells communicate effectively. During training, the pattern generator 100 can be programmed to generate a wide variety of test patterns, each focusing on different aspects of the DRAM interface, such as signal integrity, voltage levels, and timing margins. These patterns help in fine-tuning the interface’s parameters and ensure the interface performs correctly across various operating conditions. One aspect of DRAM training is adjusting the timing of data transfer signals to account for signal delays and jitter. The pattern generator 100 can help calibrate the timing of data signals, DQ, CA, and CS, by applying patterns that stress different timing relationships. This helps in identifying the optimal timing for data transfer, such as the read and write operations, and in detecting any issues with skew or signal degradation.

Tracking patterns are used to continuously monitor the performance of the DRAM 170 during regular operation. These patterns ensure that the DRAM 170 maintains optimal performance by checking for timing drift, signal degradation, and latency issues over time. The pattern generator 100 can produce test patterns that simulate long-duration stress by running continuous sequences of memory operations, such as burst writes or frequent refresh cycles. The pattern generator 100 can also simulate temperature-induced effects, helping the system track changes in signal quality under varying environmental conditions. These patterns may include random access sequences or stress tests that simulate real-world workloads, ensuring the DRAM 170 remains stable throughout its operational lifetime.

Stated differently, in addition to its role during the training phase, the pattern generator 100 also tracks the DRAM interface over time. Once the training and calibration phases are completed, the system needs to ensure that the DRAM interface continues to operate reliably under varying conditions. This ongoing validation process, referred to as tracking, helps to maintain the interface’s performance and detect potential issues that may arise during normal operation. As part of tracking, the pattern generator 100 helps detect errors such as data corruption, signal degradation, and timing mismatches. By continuously applying test patterns that simulate real-world data transfers, the system can detect discrepancies between expected and actual behaviors. These patterns can include edge cases and stress conditions that are likely to cause errors. For instance, patterns may be generated that push the interface to its limits in terms of timing and signal strength, helping to identify any latent issues. Over the long term, tracking ensures that the DRAM interface remains stable and reliable. The pattern generator 100 can adapt its test patterns to account for gradual changes in the interface, such as aging effects or shifts in environmental conditions. This adaptability makes the system robust in maintaining peak performance over time, rather than relying solely on the initial training process. The pattern generator 100 can continuously update the calibration of the interface by executing updated or new pattern sequences.

After the training phase, post-training maintenance is performed to ensure that the DRAM 170 continues to perform well over time, even as environmental conditions, aging, or system-level changes may affect its behavior. The pattern generator 100 is capable of producing maintenance patterns that test the system’s resilience to changes in signal integrity, timing shifts, and other environmental effects. For example, the pattern generator 100 may generate refresh patterns that verify memory retention over long periods or simulate low-voltage operations to test the DRAM’s behavior under varying power supply conditions. The pattern generator 100 can also produce sequences that check for error recovery capabilities by running error injection patterns that simulate faults in the interface and ensure that error-correction mechanisms are functioning correctly.

Stated differently, the pattern generator 100 assists in post-training maintenance by executing a series of predefined maintenance patterns that help track the DRAM interface’s ongoing performance. These patterns are applied regularly to ensure that the interface continues to meet the designated specifications, and any discrepancies or degradations are detected early. Even after the initial training phase, the pattern generator 100 can continue to drive a series of maintenance patterns to monitor the health and performance of the DRAM interface. These patterns test aspects such as signal integrity, voltage levels, and timing, ensuring that the interface continues to function within optimal parameters. By applying these patterns over time, the pattern generator 100 helps track long-term trends, such as aging effects, thermal drift, or changes in workload, all of which may impact DRAM performance. The pattern generator 100 aids in maintaining the long-term stability of the DRAM interface. By periodically executing the pre-configured maintenance patterns, the system can optimize the interface’s performance, ensuring it remains stable over time. These patterns can also be used to recalibrate or fine-tune the DRAM interface as part of regular maintenance cycles, thus maintaining peak performance across different operational conditions. The continuous execution of maintenance patterns also contributes to preventive maintenance. By running these tests regularly, the system can identify potential issues before they lead to critical failures or significant performance drops.

By generating patterns for all phases (e.g., initialization, training, tracking, and maintenance), the pattern generator 100 ensures that the DRAM 170 is tested thoroughly, not just at a single point in time but across its entire lifecycle. This increases confidence in the DRAM’s reliability and performance. A pattern generator that spans all phases eliminates the need for multiple separate tools or pattern generators. This ensures test consistency, as the same pattern generator can handle initialization, training adjustments, continuous tracking, and post-training checks, maintaining uniformity in test procedures. By testing the DRAM interface through different phases, the system can ensure that it performs optimally during not just the initial training period but throughout its use, temperature fluctuations, and power variations.

The pattern generator 100 can support adaptive testing, automatically adjusting test parameters based on feedback from the system (e.g., error rates or timing violations) during the training and maintenance phases. This reduces manual intervention and improves testing throughput. For ongoing maintenance, the ability to track memory performance over time and under different operational conditions helps detect potential issues early, allowing for timely interventions and ensuring system stability in long-running applications. The pattern generator 100 is not limited to only testing DRAM interfaces. The pattern generator 100 can also be used for I/O calibration, training for the DRAM interface, and boot-up initialization. In all the examples described herein, the pattern generator 100 can be used for such multiple functions beyond just testing DRAM interfaces. The examples describing the testing scenario are merely used for illustrative purposes and should not limit the functions of the pattern generator 100 is any way.

In a practical application, in a DRAM training system, the pattern generator 100 can execute the following sequence of operations. In an initialization phase, a sequence is loaded that ensures all DRAM cells are powered and properly initialized, with pre-charge and row activation commands executed sequentially. In a training phase, a series of timing and voltage stress tests is commenced, including ramp-up patterns for data writes, read latency tests, and eye margin evaluations. This may involve nested loops with different timing delays to fine-tune the system. In a tracking phase, continuous access patterns are executed, including random read/write operations and refresh cycles, to ensure the DRAM 170 remains stable over time. These patterns may be adjusted based on feedback from the training phase. In a post-training maintenance phase, after the DRAM 170 has been trained, a series of patterns is run to simulate aging effects, such as running long-duration stress tests under varying voltage conditions, to ensure that the system maintains its performance over extended periods.

As a result, the ability to generate a wide range of patterns for all stages of the DRAM interface lifecycle, including initialization, training, tracking, and post-training maintenance, enhances the functionality and efficiency of the pattern generator 100. This approach ensures that the DRAM 170 is validated under a wide variety of conditions, not only during the initial setup but also throughout its operational life. The flexibility and scalability of the pattern generator 100 across all phases improve test accuracy, reduce the need for manual reconfiguration, and ensure long-term system stability.

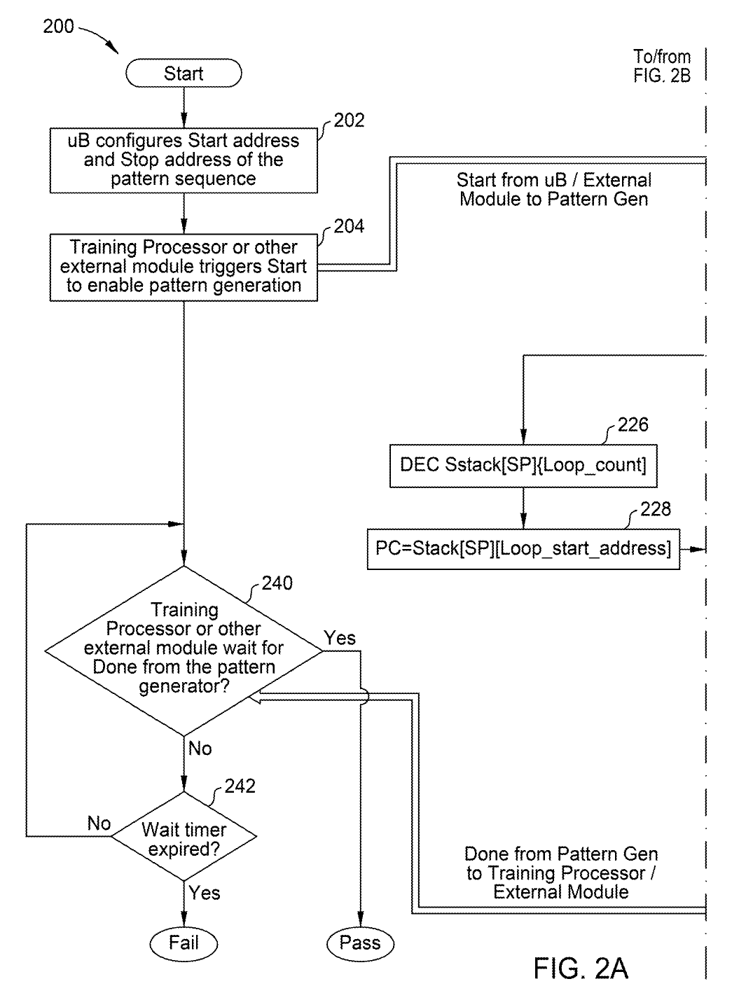

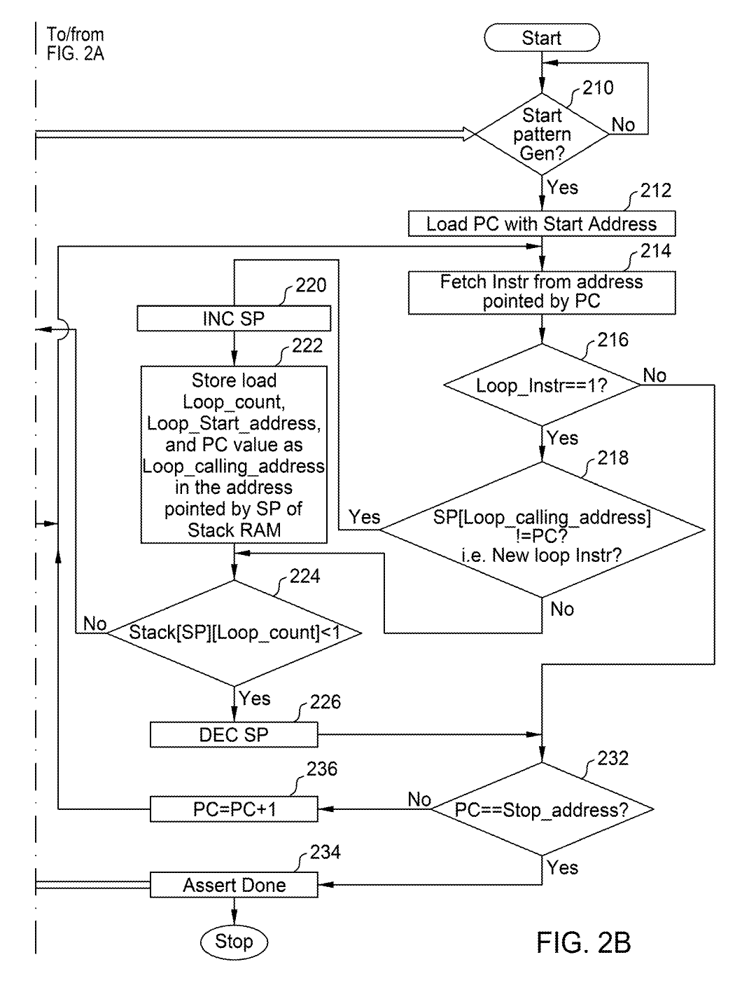

FIGS. 2A-2B illustrate an execution flow 200 of the pattern generator 100, according to an example.

At 202, the training processor 125 configures the start address and the stop address of the pattern sequence. The start address defines where the pattern sequence begins in the pattern RAM 150 and/or the instruction RAM 130. The sequencer 110 fetches and executes from this address. The stop address defines where the pattern sequence ends. The sequencer 110 halts or loops based on the control logic.

At 204, the training processor 125 or other external module triggers the start to enable pattern generation.

At 210, the pattern generator flow commences and it is determined whether to start the pattern generation. The pattern generation is initiated by the training processor 125 and managed by the sequencer 110, which executes stored instructions to produce specific bit sequences. If pattern generation can commence, the process proceeds to operation 212.

At 212, the PC 112 is loaded with the start address to begin pattern execution. The PC 112 functions as a pointer to fetch instructions or pattern data from the memory (e.g., the pattern RAM 150 or the instruction RAM 130).

At 214, the instruction is fetched from the address pointed by the PC 112. The sequencer 110 fetches such instruction. The instruction can be a data pattern command, a control command, a loop directive, or a branch operation.

At 216, it is determined whether the instruction is a loop instruction. A loop instruction is a control instruction that allows a sequence of operations to repeat for a specified number of iterations or until a certain condition is met. For a DRAM interface, a loop instruction enables efficient execution of test sequences without the need for external intervention.

At 218, if the instruction is a loop instruction, it is determined if it is a new loop or a continuation of an existing loop. A new loop refers to initiating a fresh loop iteration, resetting the loop counter, and setting up execution. A continuation of an existing loop refers to resuming of decrementing the loop counter without reinitializing the loop state. The distinction can be handled using loop control logic, which tracks loop counters, loop stacks, and loop exit conditions.

At 220, if the instruction is a new loop instruction, the stack pointer (SP) is incremented to store the new loop. In other words, the SP is incremented to allocate space for the new loop. The loop’s metadata is stored in the loop stack.

At 222, the loop count, loop start address, and PC are stored in the stack RAM at the address pointed by the SP. Thus, the loop count is stored in the stacked RAM at the address indexed by the SP.

In other words, according to operations 212, 214, 216, 218, 220, and 222, the program is running a sequence of instructions. It keeps track of loops using a stack. When the loop finishes, the program removes the loop from the stack by decreasing the SP. After this, it checks whether the current instruction address (PC) is the stop address, as described below.

At 224, it is determined whether the loop count is less than 1. If yes, the process proceeds to operation 230. If no, the operation proceeds to operation 226.

At 230, if the loop count is less than 1, the SP is decremented.

At 232, the PC is updated to the loop start address.

At 226, if the loop count is not less than 1, the stack is decremented.

At 228, the PC is set to the stored loop start address to repeat the loop.

At 232, after operation 230, it is determined whether the PC is equal to the stop address. That is, it checks whether the current instruction address is the stop address. If yes, the process proceeds to operation 234. If no, the process proceeds to operation 236.

At 236, if no, the program moves to the next instruction by increasing the PC by 1 and continues running.

At 234, if yes, the program has completed its task, so it signals “done” and stops. Once the program is done, the process transitions to the training processor.

At 240, the training processor or other external module waits for the done signal from the pattern generator 100. If yes, the training was successful, and the training processor 125 moves to the pass state, indicating that everything worked correctly. If no, at 242 it is determined whether the wait time has expired. If yes, the training was not successful, and it may trigger a retry, apply corrections or go to a fail state.

In other words, regarding operations 232, 234, 240, 242, the sequencer 110 runs through a set of instructions for training. When the sequencer 110 reaches a stop condition, the sequencer 110 signals done to the training processor 125. The training processor 125 checks if the training results meet the expected criteria. If everything looks good, it moves to the pass state (training is complete). If something went wrong, it moves to the fail state.

To summarize the execution flow 200, the initialization phase sets up the pattern generator 100, ensuring that all components are properly configured before the execution of any pattern sequences. During this phase, the sequence configuration register 120 is programmed by the training processor 125 to configure the sequencer’s operation. This includes setting parameters such as pattern generation mode, clock speed, and any specific settings related to loop handling or conditional branching. The instruction RAM 130 is populated with a set of instructions that define the pattern generation logic. These instructions include data writes, read operations, command sequences, and loop controls. The pattern RAM 150 is preloaded with the actual patterns (data, commands, and control signals) to be applied to the DRAM interface 170. These patterns are organized according to the sequence instructions stored in the instruction RAM 130. The PC 112, which tracks the current instruction in the sequence, is initialized to the starting address of the first instruction in the instruction RAM 130.

After initialization, the instruction fetch phase begins. This is where the sequencer 110 retrieves instructions from the instruction RAM 130 to guide the execution of the test patterns. The sequencer 110 fetches the current instruction pointed to by the PC 112. The instruction includes details about the operation to be performed (e.g., data writing, command generation, or loop control). Once the instruction is fetched, the sequencer 110 decodes it to determine the required action. The instruction may involve fetching data from the pattern RAM 150, modifying internal control states, adjusting timing, or branching to another part of the sequence. After fetching and decoding the instruction, the PC 112 is updated to point to the next instruction in the sequence, preparing for the next cycle of execution.

In the pattern generation stage, the pattern RAM 150 is accessed to retrieve the actual patterns that will be applied to the DRAM interface 170. The pattern generation phase drives the DRAM interface 170 with the necessary test data, commands, and control signals. Based on the current instruction, the sequencer 110 provides a pointer to the appropriate location in the pattern RAM 150, where the test patterns for the DQ, CA, and CS lines are stored. Once the patterns are fetched, they are applied to the relevant DRAM interface lines. This involves generating the appropriate voltage levels or signal states on the DQ, CA, and CS lines according to the fetched pattern. To minimize latency, the system may prefetch the next set of patterns before they are needed, ensuring that the sequencer 110 can apply the next pattern immediately once the current one is completed.

The loop handling phase allows the pattern generator 100 to repeat certain sequences or patterns, optimizing the testing process and ensuring comprehensive testing across multiple iterations. Certain instructions within the instruction RAM 130 define loops, such as repeated data writes or command sequences. The sequencer 110 handles these loops by referring to the loop control instructions, which specify the start, end, and iteration count. A stack-based approach is used for managing loops. The sequencer 110 pushes the current instruction pointer to a stack when entering a loop and pops it when exiting the loop, ensuring that the correct instruction flow is maintained across iterations. Loops are executed efficiently, with the sequencer 110 quickly jumping to the loop start and iterating until the specified number of repetitions is reached. Once the loop completes, the sequencer 110 continues executing subsequent instructions as defined in the sequence.

The sequence execution phase involves the overall flow and control of the testing process. This phase is where the actual execution of the test sequence occurs, involving a combination of pattern application, instruction fetching, loop handling, and conditional branching. The sequencer 110 proceeds through the instructions in the instruction RAM 130 in a sequential manner, unless a loop or conditional branch alters the flow. During this phase, the sequencer 110 generates patterns from the pattern RAM 150, applies them to the DRAM interface 170, and handles any branching or looping logic. Once all instructions have been executed, the sequencer 110 either halts or moves to a different test sequence, depending on the test requirements. The pattern generator 100 ensures that all necessary patterns have been applied to the DRAM interface 170 to complete the test.

Therefore, the pattern generator 100 significantly enhances the testing process for DRAM interfaces by providing enhanced storage capacity, efficient loop handling, and the ability to pre-configure multiple pattern sequences. These improvements allow for a more flexible, scalable, and efficient approach to generating the necessary test patterns, ensuring that the DRAM interface undergoes comprehensive and effective validation across all stages of its lifecycle.

The pattern generator 100 has increased storage capabilities, allowing for the storage of multiple test patterns and longer pattern sequences. This eliminates the need for frequent reconfiguration or the continuous loading of patterns, streamlining the test process and reducing the burden on the training processor. Pattern RAM and instruction RAM are optimized to accommodate a larger number of sequences, enabling the pattern generator 100 to handle complex testing scenarios with varying timing parameters, data patterns, and access sequences without exhausting memory resources. With enhanced storage, the pattern generator 100 can store a wide variety of test patterns for different phases of DRAM interface testing, such as initialization, training, tracking, and post-training maintenance, all in one place, facilitating smooth transitions between phases without reconfiguration.

The pattern generator 100 supports efficient loop handling with features such as nested loops and stack-based management. This allows the system to handle complex sequences with multiple layers of iteration, such as testing different data patterns across a range of memory addresses or timing variations. By enabling nested loops, the pattern generator 100 can efficiently manage repetitive tasks such as running multiple variations of read/write sequences, adjusting parameters like timing delays or voltage levels for each iteration, and testing DRAM cells under different conditions without reloading the entire pattern set. The stack-based approach ensures that loops are handled efficiently without overwhelming the pattern generator’s resources, allowing for better performance and faster execution of complex tests.

The pattern generator 100 allows for the pre-configuration of multiple test sequences, which can be stored in the instruction RAM for quick retrieval and execution. This eliminates the need for frequent reconfiguration during testing, significantly reducing setup time and the load on the training processor. The ability to pre-configure sequences means that different test cases, such as read/write operations, stress tests, timing margin checks, and refresh tests, can be defined in advance and executed in sequence, without manual intervention. This ensures a streamlined and efficient testing process. The pre-configured sequences can be adjusted dynamically if needed, providing flexibility while maintaining consistency across tests.

By combining enhanced storage, efficient loop handling, and the ability to pre-configure patterns, the pattern generator 100 allows for faster execution of test sequences and reduces test cycle times. This is beneficial for environments where time-sensitive validation is necessary, such as in DRAM interface designs. Additionally, the pre-configured pattern sequences reduce the need for manual oversight or intervention, enabling automated testing and freeing up resources for other tasks.

The system’s ability to handle multiple pre-configured patterns and nested loops ensures that it can scale to meet the demands of increasingly complex DRAM interfaces and larger memory systems. As memory technologies evolve (e.g., DDR6) and need more sophisticated testing, the pattern generator 100 can accommodate these growing demands. With the combination of increased storage and efficient loop management, the pattern generator 100 is capable of testing DRAM interfaces at higher data rates, longer durations, and more intricate operational conditions.

In a practical application, a DRAM interface may need to be tested for various stages of its lifecycle. During initialization, a sequence is needed to bring the DRAM into a known state, which involves running initialization patterns (e.g., power-up, pre-charge cycles, and address mapping). During training, a set of training sequences is used that test the timing and voltage margins, such as read/write stress tests and eye margin evaluations, with varying timing parameters and data patterns. During post-training maintenance, patterns that simulate aging effects and long-term operation are used, such as refresh cycles, low-voltage stress tests, and error recovery checks. With the pattern generator 100, all of these test sequences can be pre-configured and stored in the pattern generator’s memory. When it is time to execute the test, the sequencer 110 can access and run these pre-defined sequences with minimal setup or reconfiguration, ensuring that testing proceeds smoothly and efficiently.

As a result, the pattern generator 100 offers a highly efficient solution for DRAM interface testing by combining enhanced storage capacity, efficient loop handling, and the ability to pre-configure multiple pattern sequences. These features streamline the testing process, reducing setup time, improving test coverage, and increasing performance. By supporting a wide range of test patterns across all stages of the DRAM interface lifecycle, this approach ensures that the DRAM interface is thoroughly validated and remains reliable under varying operational conditions.

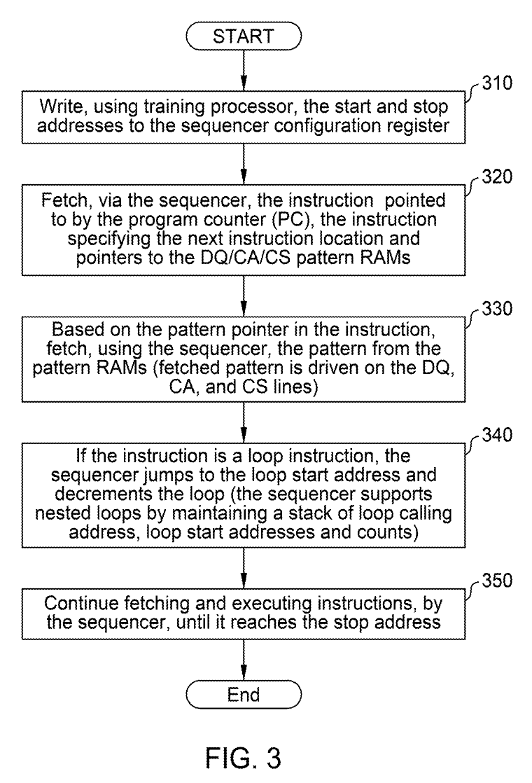

FIG. 3 illustrates a method for running the pattern generator of FIGS. 1A-1B, according to an example.

At 310, during initialization, the training processor writes the start and stop addresses to the sequencer configuration register. The sequencer loads the start address into the PC and begins fetching instructions from the instruction RAM.

At 320, the sequencer fetches the instruction pointed to by the PC. The instruction specifies the next instruction location and pointers to the DQ/CA/CS pattern RAMs.

At 330, based on the pattern pointer in the instruction, the sequencer fetches the pattern from the pattern RAMs. The fetched pattern is driven on the DQ, CA, and CS lines.

At 340, if the instruction is a loop instruction, the sequencer jumps to the loop start address and decrements the loop count. The loop count, loop calling address, and loop start address are stored in the stack RAM. The sequencer supports nested loops by maintaining a stack of loop calling address, loop start addresses and counts.

At 350, the sequencer continues fetching and executing instructions until it reaches the stop address. Each instruction is executed in a single clock cycle, ensuring efficient pattern generation.

Referring to FIGS. 1-3, the benefits of the example pattern generator for the DRAM interface include reduced code size and runtime, reduced reconfiguration time, enhanced storage capacity, efficient loop handling, single-cycle instruction execution, versatility, and improved performance and reliability.

One advantage of the example pattern generator is its ability to reduce the code size and overall runtime. By pre-configuring multiple pattern sequences and utilizing efficient loop handling, the pattern generator eliminates the need for large and complex instruction sets. Instead of using separate instructions for each individual pattern, the system can store and execute more compact instructions that reference pre-configured patterns, resulting in smaller code. This reduction in code size leads to faster execution times, enabling quicker testing cycles and enhanced overall throughput.

The pattern generator significantly reduces reconfiguration time by enabling the storage of multiple pattern sequences in advance. Since these sequences are preloaded into the instruction RAM and the pattern RAM, the system does not need frequent reprogramming between tests. Once the initial configuration is set, the sequencer can execute subsequent patterns and sequences without needing to reconfigure the system for each new test. This efficiency minimizes downtime, allowing the testing process to run continuously and maximizing system uptime for DRAM interface validation.

With enhanced storage capacity in both the instruction RAM and the pattern RAM, the pattern generator can store multiple complex pattern sequences that are readily available for testing. This increased storage allows for more diverse and comprehensive test scenarios, which can be beneficial for verifying the behavior of DRAM interfaces under various conditions. The ability to store a larger set of patterns and sequences ensures that the system can handle a wider range of testing phases, from initialization and training to maintenance and troubleshooting.

The system’s ability to handle nested loops efficiently through a stack-based approach is a significant advantage. Instead of executing repetitive instructions or sequences individually, the sequencer can loop through a series of patterns with minimal overhead. This enables faster execution of complex pattern sequences, reducing the number of clock cycles used to complete repetitive tests. Efficient loop handling also reduces the overall load on the training processor, enabling it to focus on higher-level tasks and enhancing the system’s overall performance.

With single-cycle instruction execution, the pattern generator can execute each instruction in a single clock cycle, ensuring that patterns are applied to the DRAM interface at high speed. This feature minimizes delays in the testing process, contributing to faster pattern generation and reduced testing times. Single-cycle execution also helps the system maintain high throughput while avoiding bottlenecks that could arise from slower instruction processing, particularly during intensive test scenarios.

The pattern generator’s versatility is another advantage. The system can support a variety of DRAM interfaces, including different generations of DRAM, data widths, and clock speeds. It is easily adaptable to the changing requirements of DRAM testing, ensuring compatibility with a wide range of memory technologies. Additionally, the pattern generator can handle multiple stages of testing, such as initialization, training, tracking, and post-training maintenance, without the need for major reconfigurations.

Overall, the combination of reduced code size, efficient execution, and enhanced storage capacity leads to improved system performance. The ability to execute test patterns quickly, with minimal reconfiguration and overhead, accelerates the testing process, making the system more efficient and reliable. Furthermore, the use of pre-configured pattern sequences and optimized loop handling ensures consistent and accurate testing, enhancing the reliability of the DRAM interface validation process. This leads to more robust systems with fewer errors and improved overall performance, which is crucial in high-speed and high-accuracy memory applications.

In conclusion, the example pattern generator for DRAM interfaces represents a significant advancement in memory testing technology. By incorporating pre-configured pattern storage, the system eliminates the need for frequent reconfiguration, streamlining the testing process and significantly reducing setup time. This feature allows a wide variety of test patterns to be pre-stored and readily available, enabling quick transitions between different testing phases, such as initialization, training, tracking, and post-training maintenance. With enhanced storage capacity, the generator can store longer and more complex test sequences without running out of memory, thus ensuring comprehensive testing without sacrificing performance or requiring constant pattern reloads.

Moreover, the example pattern generator offers versatility in supporting multiple DRAM interfaces and training requirements. Its scalability makes it capable of adapting to future DRAM technologies (e.g., DDR6), ensuring that it can be easily configured to handle new memory types, such as DDR, LPDDR, HBM, or emerging memory standards. Whether testing low-speed consumer-grade DRAM or high-bandwidth memory systems, the pattern generator is capable of adjusting to varying memory architectures, clock frequencies, and data widths. This flexibility makes it a valuable tool for a wide range of applications, from consumer electronics to high-performance computing.

Efficient loop handling is another feature of the example pattern generator. The system’s ability to manage nested loops and execute them in a stack-based approach ensures that complex test sequences with multiple iterations can be executed efficiently, without introducing bottlenecks. The combination of single-cycle instruction execution and efficient loop management enables the generator to maintain high throughput, which is crucial for high-speed DRAM interfaces operating at modern data rates. The ability to execute each instruction in a single clock cycle minimizes latency, ensuring that the pattern generator can keep pace with fast memory operations and generate patterns without delay.

In addition to high-speed execution, the example pattern generator's adaptability to various testing conditions and DRAM interfaces makes it an ideal solution for validation and training requirements. It allows for easy adjustments to test sequences based on specific parameters, such as timing, voltage, and data integrity checks, making it a versatile tool for thorough memory validation. With its scalable and adaptable architecture, the pattern generator provides a solution that can continue to meet the evolving demands of DRAM testing. Overall, the example pattern generator offers a comprehensive, efficient, and flexible approach to DRAM interface validation, ensuring that DRAM systems are thoroughly tested and validated for performance, reliability, and long-term functionality.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A pattern generator comprising:
a control memory configured to store multiple pattern sequences that are pre-configured;
a sequencer configured to interpret the multiple pattern sequences stored in the control memory and trigger data and command patterns onto a dynamic random access memory (DRAM) interface; and
a test data memory configured to store the data and command patterns to be applied to the DRAM interface during a test process.

2. The pattern generator of claim 1, wherein the control memory includes an instruction random access memory (RAM) and the test data memory includes a pattern RAM.

3. The pattern generator of claim 2, wherein the pattern RAM includes a data (DQ) pattern RAM and a command (CMD) pattern RAM.

4. The pattern generator of claim 1, wherein the multiple pattern sequences are each defined by a series of instructions, each instruction including at least a loop control field, pattern pointers, and branching information.

5. The pattern generator of claim 1, wherein the sequencer communicates with a stack RAM that manages loop execution using parameters including loop start address, loop count, and loop calling address.

6. The pattern generator of claim 1, wherein a sequencer configuration register communicates with a training processor, the sequencer configuration register adapted to configure parameters including a sequence start address, a sequence repeat count, timing information, and control signals to start and stop the sequencer.

7. The pattern generator of claim 1, wherein the sequencer is configured to support nested loops with a stack-based configuration.

8. The pattern generator of claim 1, wherein the multiple pattern sequences are generated for different stages of the DRAM interface including initialization, training, tracking, and post-training maintenance.

9. The pattern generator of claim 1, wherein the sequencer executes each instruction from the control memory in a single clock cycle.

10. A pattern generator comprising:
a sequencer configured to interpret multiple pattern sequences that are pre-configured and stored in an instruction random access memory (RAM), wherein the multiple pattern sequences are generated for different stages of a dynamic RAM (DRAM) interface including initialization, training, tracking, and post-training maintenance; and
a pattern RAM including a data (DQ) pattern RAM and a command (CMD) pattern RAM, wherein the pattern RAM is configured to store data and command patterns to be applied to the DRAM interface during a test process.

11. The pattern generator of claim 10, wherein the multiple pattern sequences are each defined by a series of instructions, each instruction including at least a loop control field, pattern pointers, and branching information.

12. The pattern generator of claim 10, wherein the sequencer communicates with a stack RAM that manages loop execution using parameters including loop start address, loop count, and loop calling address.

13. The pattern generator of claim 10, wherein the sequencer executes each instruction from the instruction RAM in a single clock cycle.

14. A method comprising:
writing, using a training processor, a start address and a stop address to a sequence configuration register;
loading, using a sequencer, the start address on a program counter;
fetching, using the sequencer, instructions from a control memory, each instruction specifying a next instruction location and pattern pointers to a test data memory;
based on a pattern pointer in an instruction, fetching, using the sequencer, a pattern from the test data memory; and
fetching and executing, using the sequencer, the instructions until the stop address is reached.

15. The method of claim 14, further comprising determining whether the instruction is a loop instruction.

16. The method of claim 15, wherein, if the instruction is a loop instruction, the sequencer proceeds to a loop start address and decrements a loop count.

17. The method of claim 16, wherein the loop count, a loop calling address, and a loop start address are stored in a stack RAM communicating with the sequencer.

18. The method of claim 14, wherein each instruction from the control memory in a single clock cycle.

19. The method of claim 14, wherein the control memory includes an instruction random access memory (RAM) and the test data memory includes a pattern RAM.

20. The method of claim 19, wherein the pattern RAM includes a data (DQ) pattern RAM and a command (CMD) pattern RAM.
